(19) United States
(12) Patent Application Publication
(10) Pub. No.: US 2017/0051550 A1
(43) Pub. Date: Feb. 23, 2017

(54) WINDOW REGULATOR

(71) Applicant: Johnan Manufacturing Inc., Nagano (JP)

(72) Inventors: Hiroyuki IKEDA, Nagano (JP); Hideo KASHIWABARA, Nagano (JP); Hideaki TAKEHARA, Nagano (JP); Hiroki SHIMIZU, Nagano (JP); Manabu SHIMOMURA, Nagano (JP)

(21) Appl. No.: 15/227,652

(22) Filed: Aug. 3, 2016

(30) Foreign Application Priority Data
Aug. 19, 2015 (JP) 2015-162313

(51) Int. Cl. E05F 15/689; E05D 15/16; B60J 1/08

(52) U.S. Cl. CPC E05F 15/689; B60J 1/08; E05D 15/16; E05Y 2201/434; E05Y 2201/684; E05Y 2201/654; E05Y 2900/55; E05Y 2201/702

(57) ABSTRACT

A window regulator provided in a door of a vehicle to raise and lower a windowpane in the door. The window regulator includes a traveling body that holds the windowpane and travels together with the windowpane, a wire that pulls the traveling body, and a drive mechanism that generates a drive force to wind the wire. The traveling body includes a sub-housing that encloses at least a portion of the drive mechanism. The traveling body includes a recessed groove into which the wire is inserted and which has a depth in a plate thickness direction thereof. The sub-housing is fixed to the traveling body while striding across the recessed groove.

The present application is based on Japanese patent application No. 2015-162313 filed on Aug. 19, 2015, the entire contents of which are incorporated herein by reference.

### BACKGROUND OF THE INVENTION

1. Field of the Invention

The invention relates to a window regulator to raise and lower a windowpane or window glass) in a vehicle door.

2. Description of the Related Art

A window regulator is used in a vehicle door so as to raise and lower the windowpane by a drive force of a motor (see, e.g., JP-A 2014-43686).

The window regulator described in JP-A 2014-43686 is provided with a guide rail fixed to a door inner panel along the travel direction of a windowpane which is an object to be opened and closed, a wire tightly stretched along the longitudinal direction of the guide rail, a resin carrier plate as a traveling body traveling with the windowpane while being guided by the guide rail, and a drive mechanism provided at a lower end of the guide rail to drive the carrier plate via the wire.

The drive mechanism has a drum with a wire wound around the outer peripheral surface thereof and a motor to rotate the drum. The drum is rotatably held in a housing and the motor is supported by the housing. In addition, a direction change member for changing the direction of the wire is arranged at an upper end section of the guide rail. The wire is routed between the drum and the direction change member and is fixed, at both ends, to the traveling body.

The both ends of the wire are fixed to the carrier plate via looseness-preventing springs. The wire is thereby tensioned. When the wire from the drum to the traveling body via the direction change member is defined as a raising wire and the wire from the drum directly reaching the carrier as a lowering wire, the drive unit operates such that the motor rotates forward during ascent of the carrier plate to take up the raising wire and to let out the lowing wire, and the motor rotates reversely during descent of the carrier plate to take up the lowing wire and to let out the raising wire. The windowpane thereby moves vertically together with the carrier plate.

### SUMMARY OF THE INVENTION

The carrier plate which raises or lowers the windowpane while supporting the weight of the windowpane is subjected to a large load applied thereto especially when the windowpane is raised. Also, the housing which holds and supports the drum and the motor is subjected to some load from a torque of the motor. However, because the carrier plate and the housing are provided with a groove etc. so as to insert the raising wire and the lowering wire, it is difficult to enhance the rigidity thereof. In order to secure a required rigidity or durability, it is necessary to have a sufficient thickness at e.g. the bottom portion of the groove. This may cause an increase in thicknesses of the carrier plate and the housing and also cause an increase in weight thereof.

It is an object of the invention to provide a window regulator that can be reduced in size and weight while securing the rigidity of the carrier plate and the housing.

(1) According to an embodiment of the invention, a window regulator provided in a door of a vehicle to raise and lower a windowpane in the door comprises:
a guide rail arranged along the travel direction of the windowpane;
a wire tensely fitted along the longitudinal direction of the guide rail; and
a traveling body that is guided along the guide rail and travels together with the windowpane,
wherein the traveling body comprises a drum with a portion of the wire wound thereon, a drive mechanism that rotationally drives the drum and a housing that holds the drum and the drive mechanism,
wherein the housing comprises a drum housing with a housing space in which the drum is enclosed and a sub-housing fixed to the drum housing to house at least a portion of the drive mechanism,
wherein the drum housing comprises a recessed groove into which the wire is inserted and which communicates with the housing space, and first and second regions divided by the recessed groove and the housing space,
wherein the sub-housing comprises a main body that encloses at least a portion of the drive mechanism and a plurality of fixed portions at which the sub-housing is fixed to the drum housing, and
wherein the fixed portions comprise a first fixed portion that is fixed to the first region and a second fixed portion that is fixed to the second region.

In the above embodiment (1) of the invention, the following modifications and changes can be made.

(i) The plurality of fixed portions of the sub-housing further comprise a third fixed portion that is at a position offset in a direction perpendicular to a virtual line connecting the first fixed portion and the second fixed portion in a plan view along a width direction of the vehicle.

(ii) The first and second regions of the drum housing each comprise a joint portion at which the drum housing is jointed to the windowpane.

(iii) The plurality of fixed portions of the sub-housing are each fixed to the drum housing by a bolt or a rivet.

(2) According to another embodiment of the invention, a window regulator provided in a door of a vehicle to raise and lower a windowpane in the door comprises:

a traveling body that holds the windowpane and travels together with windowpane; and

a wire that pulls the traveling body,

wherein the traveling body comprises a drum with a portion of the wire wound thereon, a drive mechanism that rotationally drives the drum and a housing that holds the drum and the drive mechanism,

wherein the housing comprises a drum housing with a housing space in which the drum is enclosed and a sub-housing fixed to the drum housing to house at least a portion of the drive mechanism,

wherein the drum housing comprises a recessed groove in to which the sire is inserted and which communicates with the housing space, first and second regions divided by the recessed grooves and the housing space,

wherein the sub-housing comprises a main body that encloses at least a portion of the drive mechanism and a plurality of fixed portions at which the sub-housing is fixed to the drum housing, and

wherein the fixed portions comprise a first fixed portion that is fixed to the first region and a second fixed portion that is fixed to the second region.

(3) According to another embodiment of the invention, a window regulator provided in a door of a vehicle to raise and lower a windowpane in the door comprises:

a traveling body that holds the windowpane and travels together with windowpane;

a wire that pulls the traveling body; and

a drive mechanism that generates a drive force to wind the wire,

wherein the traveling body comprises a sub-housing that encloses at least a portion of the drive mechanism,

wherein the traveling body comprises a recessed groove into which the wire is inserted and which has a depth in a plate thickness direction thereof, and

wherein the sub-housing is fixed to the traveling body while striding across the recessed groove.

(4) According to another embodiment of the invention, a traveling body that is adapted to be pulled by a wire wound by a drive force of a motor and travels while holding a windowpane of a vehicle comprises:

a drum housing that encloses a cylindrical drum on which a wire is wound; and

a sub-housing that holds the motor,

wherein the drum housing comprises a recessed groove which has a depth in a plate thickness direction thereof and extends along a travelling direction of the windowpane, and

wherein the sub-housing is fixed to the drum housing while striding across the recessed groove.

In the above embodiment (4) of the invention, the following modifications and changes can be made.

(iv) The drum housing of the traveling body comprises first and second regions divided by the recessed grooves, wherein the sub-housing comprises a plurality of fixed portions that are fixed to the drum housing, and wherein the fixed portions comprise a first fixed portion that is fixed to the first region and a second fixed portion that is fixed to the second region.

### Effects of the Invention

According to an embodiment of the invention, a window regulator can be provided that can be reduced in size and weight while securing the rigidity of the carrier plate and the housing.

### BRIEF DESCRIPTION OF THE DRAWINGS

Next, the present invention will be explained in more detail in conjunction with appended drawings, wherein:

FIG. 1 is an illustration diagram showing a window regulator in a first embodiment of the present invention and a vehicle door mounting the window regulator;

FIG. 2 is a schematic cross sectional view taken along a line A-A in FIG. 1 and showing the inside of the door mounting the window regulator;

FIG. 3 is an overall view showing the window regulator;

FIG. 4 is an exploded perspective view showing the window regulator;

FIGS. 5A to 5C are diagrams showing an example configuration of a drum housing, wherein FIG. 54 is a top view, FIG. 5B is a plan view and FIG. 5C is a side view;

FIGS. 6A and 6B are illustration diagrams showing a force acting on the drum housing, wherein FIG. 6A is a top view and FIG. 6B is a front view;

FIG. 7 is a plan view showing an example configuration of a drum housing of a window regulator in a modification of the first embodiment;

FIGS. 8A and 8B are diagrams showing an example configuration of a drum housing in a second embodiment, wherein FIG. 8A is a plan view and FIG. 8B is a side view; and

FIGS. 9A to 9C are diagrams showing an example configuration of a drum housing in a third embodiment, Wherein FIG. 9A is a top view, FIG. 9B is a plan view and FIG. 9C is a side view.

### DETAILED DESCRIPTION OF THE PREFERRED EMBODIMENTS

### First Embodiment

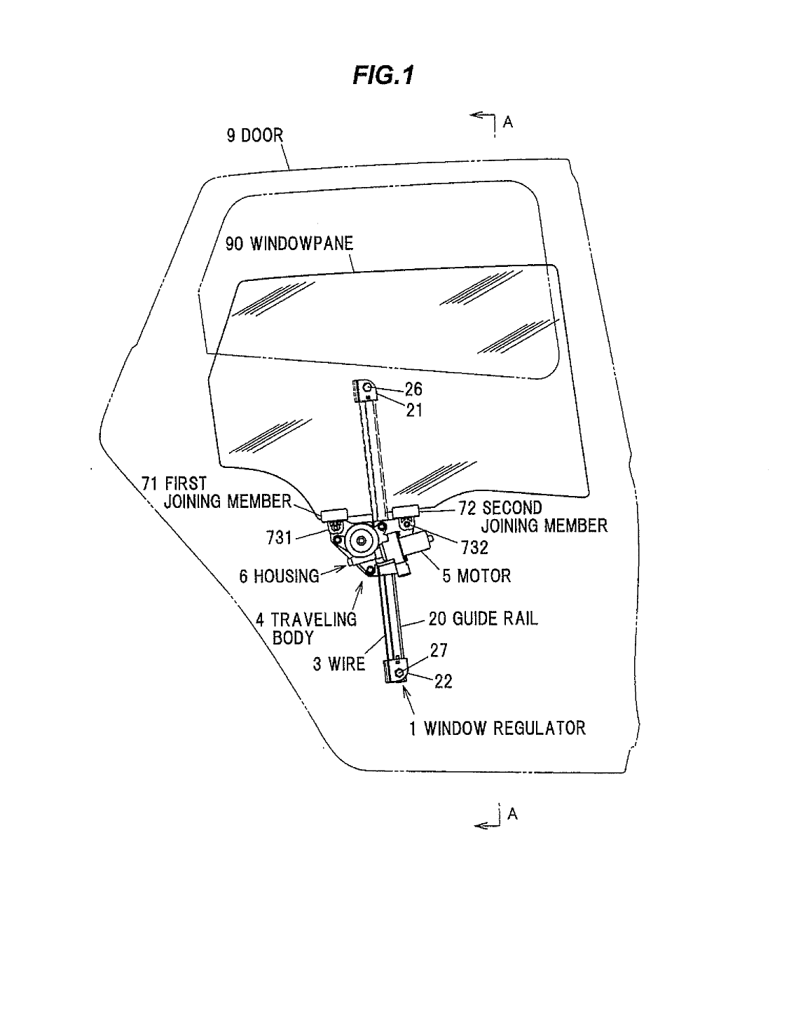

The first embodiment of the invention will be described in reference to FIGS. 1 to 5.

FICA is a schematic diagram illustrating a window regulator in the first embodiment and a vehicle door mounting the window regulator. FIG. 1 shows a right rear door when viewing from the outside of the vehicle. In addition, in FIG. 1, the outline of the door and the window frame are indicated by phantom lines (dash-dot-dot lines), and a portion of the window regulator arranged on the inner side (the vehicle interior side) of the windowpane is indicated by a dashed line.

A window regulator 1 is provided in a door 9 of a vehicle to raise and lower a windowpane 90 of the door 9. The windowpane 90 moves vertically while being guided by a window guide (not shown). Although FIG. 1 shows an example in which the window regulator 1 is used in the right rear door of the vehicle, it is also possible to provide the window regulator 1 in another door of the vehicle.

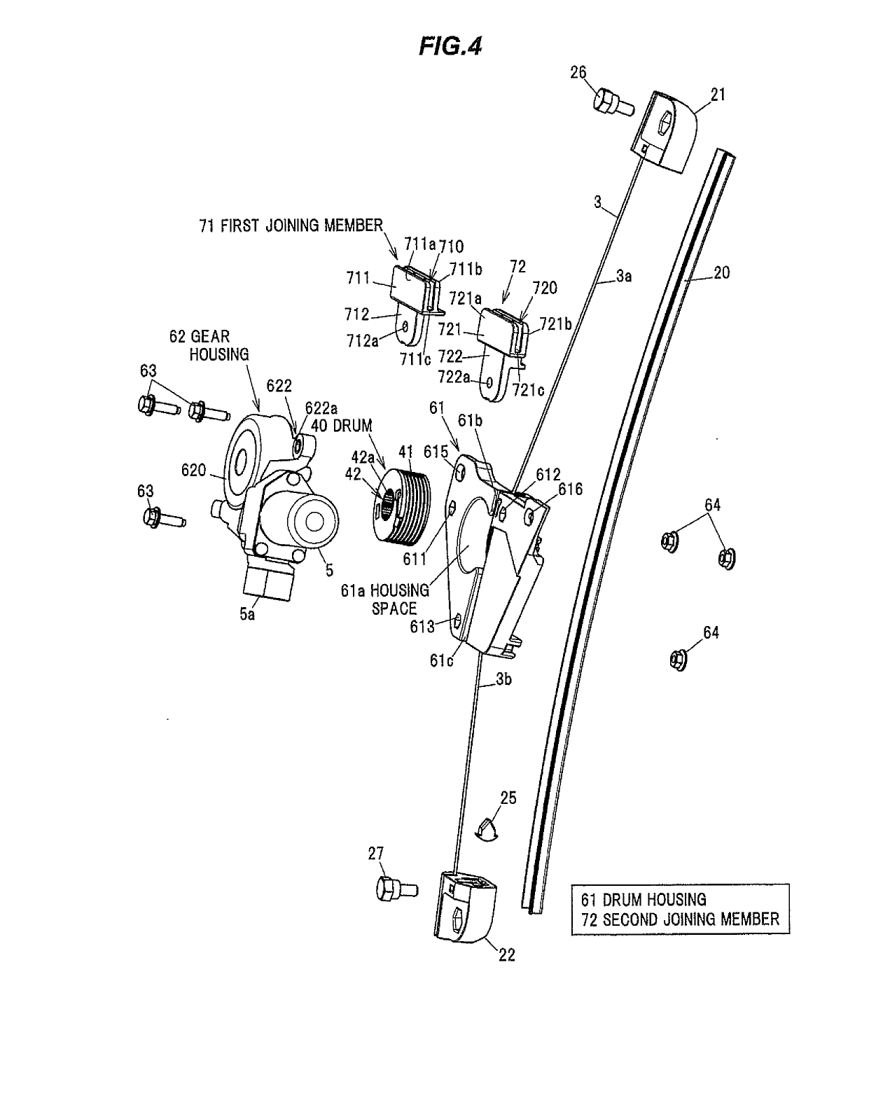

The window regulator 1 is provided with a guide rail 20 arranged along the travel direction of the windowpane 90, a wire 3 tensely fitted along the longitudinal direction of the guide rail 20, and a traveling body 4 which is guided along the guide rail 20 and travels together with the windowpane 90. The traveling body 4 has a drum 40 (shown in FIG. 4 described later) with a portion of the wire 3 wound thereupon, a motor 5 as a drive unit generating a drive force to rotate and drive the drum 40, and a housing 6 holding the drum 40 and the motor 5. The housing 6 is joined to the windowpane 90 by first and second joining members 71 and 72. The detailed configuration of the traveling body 4 will be described later.

A first wire support member 21 is arranged at an upper end section of the guide rail 20, and a second wire support member 22 is arranged at a lower end section of the guide rail 20. The first wire support member 21 and the second wire support member 22 serves as a pair of wire support portions for supporting both end sections of the wire 3.

The motor 5 is arranged at a position not overlapping the first and second joining members 71 and 72 when viewing the window regulator 1 in the vehicle width direction. In more detail, the motor 5 is arranged at a downwardly offset position with respect to the second joining member 72 which is fixed to the housing 6 at an edge on the forward side of the vehicle. This reduces the thickness of the traveling body 4 in the vehicle width direction while avoiding contact of the motor 5 with the first and second joining members 71 and 72.

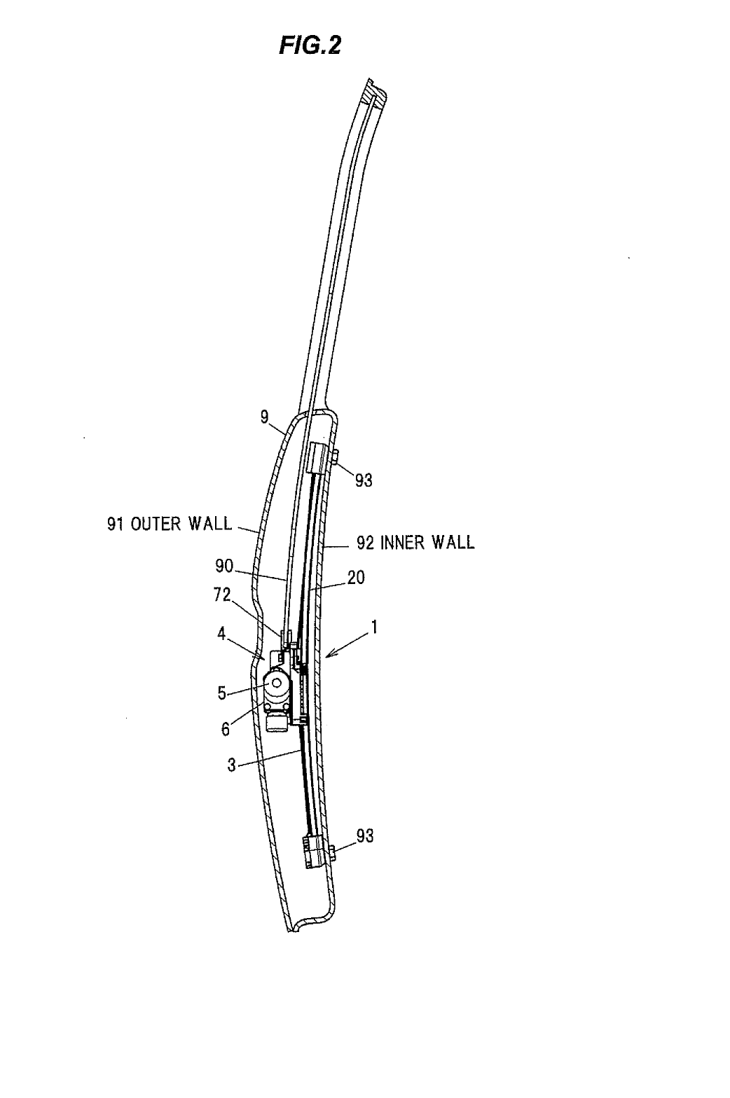

FIG. 2 is a schematic cross sectional view taken along the line A-A in FIG. 1 and showing the inside of the door 9 mounting the window regulator 1.

The window regulator 1 is arranged between an outer wall 91 and an inner wall 92 of the door 9. A surface of the inner wall 92 on the vehicle interior side (on the opposite side to the outer wall 91) is covered with a lining (not shown) formed of, e.g., a resin. The outer wall 91 is curved such that the middle portion in a height direction bulges outward in the vehicle width direction. The windowpane 90 is also curved such that the middle portion in a height direction bulges outward in the vehicle width direction, in the same manner as the outer wall 91. The guide rail 20 is curved in an arc shape along the windowpane 90.

The first wire support member 21 and the second wire support member 22 of the window regulator 1 are fixed to the inner wall 92. The first wire support member 21 is attached to the inner wall 92 by a bolt 26 (shown in FIG. 1) which is inserted through the first wire support member 21. A tip portion of the bolt 26 penetrates the inner wall 92 and is threaded into a nut 93 which is arranged on the vehicle interior side of the inner wall 92. Meanwhile, the second wire support member 22 is attached to the inner wall 92 by a bolt 27 (shown in FIG. !) which is inserted through the second wire support member 22. A tip portion of the bolt 27 penetrates the inner wall 92 and is threaded into another nut 93 which is arranged on the vehicle interior side of the inner wall 92.

The motor 5 is arranged inside the door 9 further on the outside in the vehicle width direction than the guide rail 20. A space with a width which does not disturb the movement of the traveling body 4 is formed between the guide rail 20 and the outer wall 91.

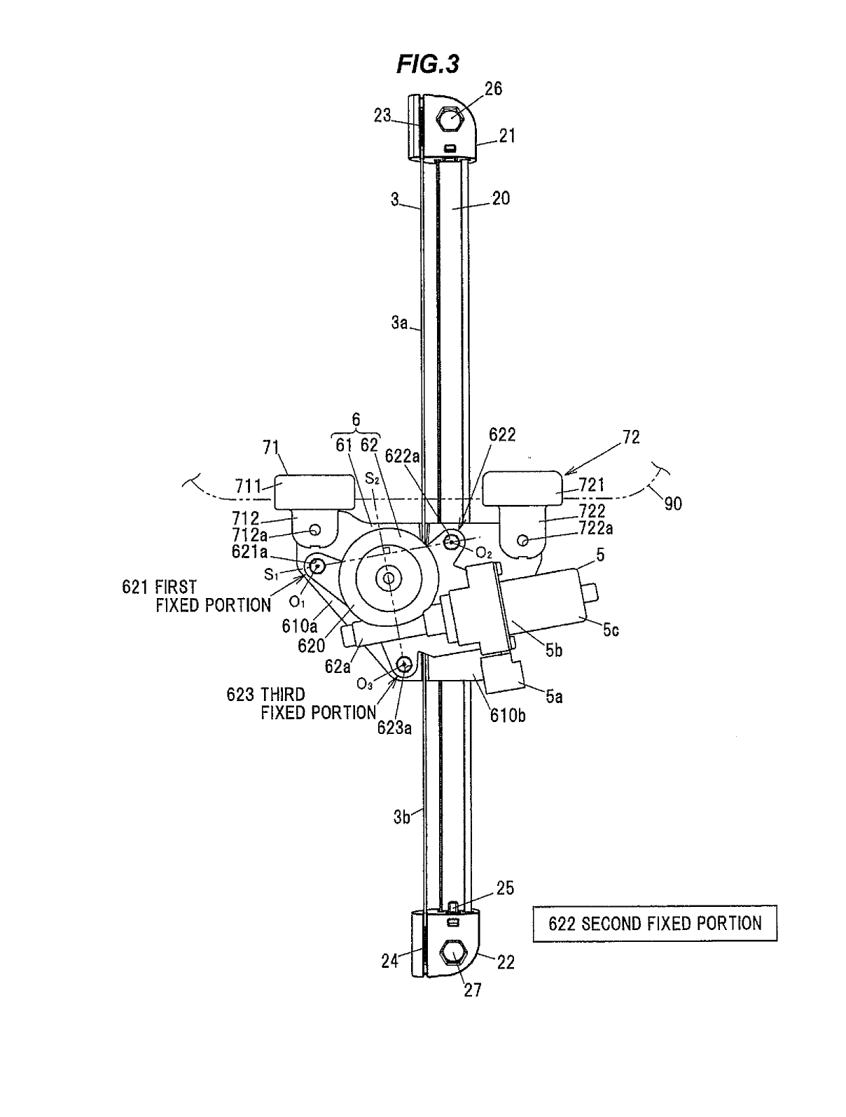

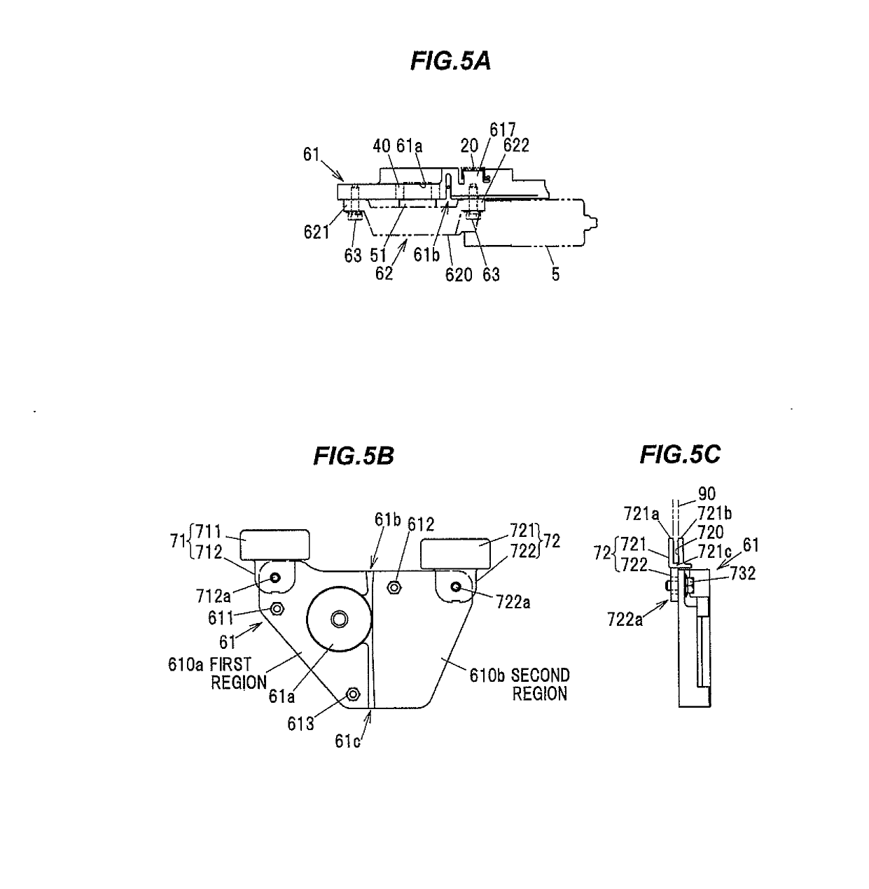

Next, the configuration of each component of the window regulator 1 will be described in detail in reference to FIGS. 3 to 5. FIG. 3 is an overall view showing the entire window regulator 1. FIG. 4 is an exploded perspective view showing the window regulator 1. FIGS. 5A to 5C are diagrams showing a configuration of a drum housing 61 of the housing 6, wherein FIG. 5A is a top view, FIG. 5B is a plan view and FIG. 5C is a side view. In the following description, “up/upper/above” and “down/lower/below” mean “an upper side” and “a lower side” of the window regulator 1 when mounted on the door 9, d “left” and “right” mean horizontal left and right sides of the window regulator 1 when mounted on the door 9 and as viewed in a direction from the outside to the inside of the vehicle.

The drum 40 is formed in a cylindrical shape and has a helical groove 41 on the outer surface thereof. In addition, inner splines 42a extending in an axial direction of the drum 40 are formed on an inner peripheral surface of a center hole 42 of the drum 40.

As shown in FIGS. 3 and 4, the housing 6 has the plate-shaped drum housing 61 for housing the drum 40 and a gear housing 62 for housing the motor 5 and a portion of a worm gear mechanism (not shown). The motor 5 and the worm gear mechanism in the embodiment correspond to the “drive mechanism” of the invention and the gear housing 62 corresponds to the “sub-housing” of the invention. Both the drum housing 61 and the gear housing 62 are formed of resins. In more detail, the drum housing 61 is formed of, e.g., polyacetal (POM) and the gear housing 62 is formed of, e.g., polybutylene terephthalate (PBT).

The motor 5 is a DC motor which receives an electric current through a connector portion 5a and generates a rotational drive force. A worm (not shown) housed in a cylindrical portion 62a of the gear housing 62 is coupled to a rotor of the motor 5 so as to rotate integrally.

The rotation of the motor 5 is decelerated by the worm gear mechanism housed in the gear housing 62 and is transmitted to the drum 40 via an output shaft Si of the worm gear mechanism. As shown in FIG. 5A, an end portion of the output shaft 51 protrudes from the gear housing 62.

As shown in FIG. 4, on the drum housing 61, a first guide groove 61b and a second guide groove 61c, which are connected to a housing space 61a housing the drum 40 and guide the wire 3 to the housing space 61a, are formed as recessed grooves having a depth in a plate thickness direction (the vehicle width direction).

The first guide groove 61b is formed above the housing space 61a and opens toward the first wire support member 21. The second guide groove 61c is formed below the housing space 61a and opens toward the second wire support member 22. The first guide groove 61b and the second guide groove 61c are formed at position offset from the center of the housing space 61a toward the guide rail 20 when viewing in the vehicle width direction shown in FIG. 3.

The gear housing 62 has a closed-end cylindrical main body 620 for housing the worm gear mechanism, and first to third fixed portions 621 to 623 as a plurality of fixed portions Which protrude radially outward from the outer circumferential surface of the main body 620 and are fixed to the drum housing 61. The first to third fixed portions 621 to 623 respectively have through-holes 621a to 623a for insertion of plural bolts 63, so that the gear housing 62 is fastened to the drum housing 61 by the plural bolts 63 inserted into the through-holes 621a to 623a and nuts 64. Although the drum housing 61 and the gear housing 62 are fastened by the bolts 63 and the nuts 64 in the first embodiment, the fastening means is not limited thereto and, for example, rivets may be used as fastener.

As shown in FIG. 5B, the drum housing 61 has a first region 610a and a second region 610b which are divided in a fore-and-aft direction of the vehicle (the left-to-right direction in FIG. 3) by the housing space 61a and the first and second guide grooves 61b and 61c. In the first embodiment, the first fixed portion 621 and the third fixed portion 623 of the gear housing 62 are fixed to the first region 610a and the second fixed portion 622 is fixed to the second region 610b. The third fixed portion 623 may alternatively be fixed to the second region 610b.

In more detail, on the plan view of the drum housing 61 as viewed in the vehicle width direction as is shown in FIG. 3, the first to third fixed portions 621 to 623 are arranged to form a triangle such that the third fixed portion 623 is provided at a position which is downwardly offset with respect to the first and second fixed portions 621 and 622 and is located on a virtual line S₂ extending in a direction perpendicular to a virtual line S₁ connecting the center O₁ of the through-hole 621a of the first fixed portion 621 to the center O₂ of the through-hole 622a of the second fixed portion 622. In this arrangement, the gear housing 62 is fixed to the drum housing 61 so as to extend over the first and second regions 610a and 610b as shown in FIG. 5A and strength of the drum housing 61 is thereby reinforced. In FIG. 5A, the gear housing 62 is indicated by a dash-dot-dot line.

As shown in FIGS. 4 and 5B, bolt insertion holes 611 to 613 for respectively inserting the plural bolts 63 are formed on the drum housing 61 at positions corresponding to the first to third fixed portions 621 to 623 of the gear housing 62. The drum housing 61 also has through-holes 615 and 616 formed at both edges in the fore-and-aft direction of the vehicle. The first and second joining members 71 and 72 are fixed to the drum housing 61 by bolts 731 and 732 (shown in FIG. 1) respectively inserted into the through-holes 615 and 616. In other words, the first and second joining members 71 and 72 are respectively provided in the first region 610a and the second region 610b of the drum housing 61. In FIG. 5A, illustration of the first and second joining members 71 and 72 is omitted for convenience of explanation. The first and second joining members 71 and 72 correspond to “joint portions” of the invention.

In addition, a protruding strip 617 extending in the vertical direction and sliding and moving on the guide rail 20 is formed on the drum housing 61. The protruding strip 617 slides and moves on the guide rail 20 and the drum housing 61 is thereby guided along the guide rail 20. The guide rail 20 is formed by bending, e.g., a metal plate such as zinc steel plate.

As shown in FIG. 4, the first joining member 71 integrally has a holding portion 711 for holding the windowpane 90, and a supported portion 712 to be supported by the drum housing 61. The holding portion 711 integrally has first and second wall portions 711a and 711b which face to each other in the vehicle width direction and sandwich and hold the windowpane 90, and a coupling portion 711c coupling the first wall portion 711a to the second wall portion 711b on the lower side.

The first and second wall portions 711a and 711b face to each other in the vehicle width direction with a predetermined gap which is formed as a housing space 710 for housing the windowpane 90. The windowpane 90 is fixed to the holding portion 711 inside the housing space 710 by; e.g., an adhesive, etc. The supported portion 712 is smaller in the left-to-right direction than the holding portion 711 and extends downward from the coupling portion 711c of the holding portion 711. An insertion hole 712a for inserting the bolt 731 (shown in FIG. 1) is formed on the supported portion 712, and the drum housing 61 is fastened to the first joining member 71 by the bolt 731.

Likewise, the second joining member 72 integrally has a holding portion 721 for holding the windowpane 90, and a supported portion 722 to be supported by the drum housing 61. The holding portion 721 integrally has first and second wall portions 721a and 721b which face to each other in the vehicle width direction and sandwich and hold the windowpane 90, and a coupling portion 721c coupling the first wall portion 721a to the second wall portion 721b on the lower side.

The first and second wall portions 721a and 721b face to each other in the vehicle width direction with a predetermined gap which is formed as a housing space 720 for housing the windowpane 90. The windowpane 90 is fixed to the holding portion 721 inside the housing space 720 by, e.g., an adhesive, etc. The supported portion 722 is smaller in the left-to-right direction than the holding portion 721 and extends downward from the coupling portion 721c of the holding portion 721. An insertion hole 722a for inserting the bolt 732 is formed on the supported portion 722, and the drum housing 61 is fastened to the second joining member 72 by the bolt 732.

The wire 3 is tensioned by springs 23 and 24 (shown in FIG. 3) which are held by the first wire support member 21 and the second wire support member 22. Thus, the wire 3 is tightly stretched without looseness between the first wire support member 21 and the second wire support member 22. The detailed configuration of the first wire support member 21 and the second wire support member 22 will be described later.

The routing path of the wire 3, which starts from the end section on the first wire support member 21 side and terminates at the end section on the second wire support member 22 side, is as follows: the wire 3 extending out of the first wire support member 21 runs downward along the guide rail 20 and is guided into the housing space 61a via the first guide groove 61b of the drum housing 61. The wire 3 guided into the housing space 61a is wound around the drum 40 several times so as to be fitted in the groove 41 on the outer surface of the drum 40, and extends out to the outside of the drum housing 61 via the second guide groove 61c. The wire 3 extending out from the second guide groove 61c runs downward along the guide rail 20 and is supported by the second wire support member 22.

When the wire 3 between the first wire support member 21 and the drum housing 61 is defined as an upper wire 3a and the wire 3 between the second wire support member 22 and the drum housing 61 as a lower wire 3b, rotation of the drum 40 causes a change in lengths of the upper wire 3a and the lower wire 3b. in other words, when the rotation direction of the drum 40 during ascent of the traveling body 4 is defined as a forward direction and the rotation direction of the drum 40 during descent of the traveling body 4 as a reverse direction, the rotation of the drum 40 in the forward direction causes the length of the upper wire 3a to be shortened and the length of the lower wire 3b to be lengthened. Inversely, the rotation of the drum 40 in the reverse direction causes the length of the upper wire 3a to be lengthened and the length of the lower wire 3b to be shortened. The traveling body 4 moves vertically along the guide rail 20 according to the change in the lengths of the upper wire 3a and the lower wire 3b.

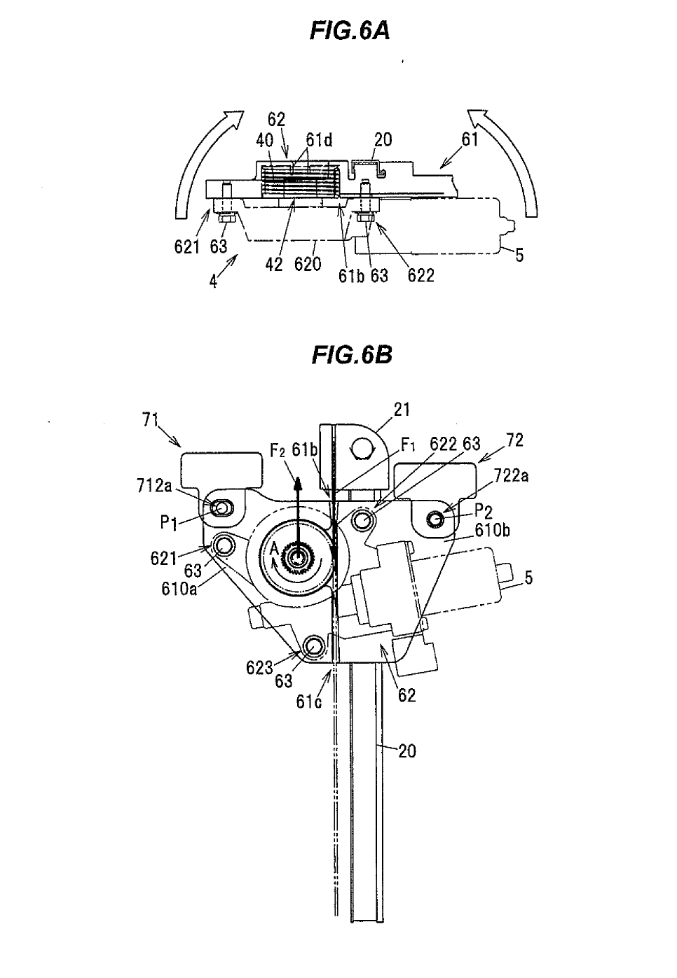

Next, a three applied to the drum housing 61 from the wire 3 when the drum 40 is rotated will be described in reference to FIGS. 6A and 68. FIGS. 6A and 68 are explanatory diagrams for explaining a force acting on the drum housing 61 when the traveling body 4 is moving, wherein FIG. 6A is a top view of the traveling body 4 and FIG. 6B is a front view of the traveling body 4.

When the drum 40 is rotated clockwise (in the arrow A direction shown in FIG. 6B) and the drum housing 61 reaches the top dead center on the guide rail 20 (the uppermost edge of the guide rail 20), a force F₂ acts on the drum housing 61 along the direction of the wire 3 arranged in the first guide groove 61b, while a tensile force F₁ acts on the wire 3 from the drum 40 via a fitting portion 61d protruding from the bottom of the housing space 61a and fitted to the center hole 42 of the drum 40. Then, due to the force F₂, a bending moment acts on the drum housing 61 in the arrow B direction shown in FIG. 6B (a direction that the width of the first guide groove 61b is widened and at the same time the width of the second guide groove 61c is narrowed).

Since the bending moment due to the component of force F₂ is applied to the drum housing 61, deformation of the drum housing 61 originated particularly from bottom portions of the first and second guide grooves 61b and 61c is likely to occur. In the first embodiment, since the gear housing 62 is fixed to the drum housing 61 so as to extend over the first and second regions 610a and 610b, the drum housing 61 receives a deformation three caused by the components of force F₁ and F₂ via the first to third fixed portions 621 to 623 of the gear housing 62 and is thus prevented from deforming. Although a force applied When the drum housing 61 reaches the top dead center on the guide rail 20 has been described above as an example, the same applies to when the drum 40 is rotated counterclockwise (a direction opposite to the arrow A direction shown in FIG. 6B) and reaches the bottom dead center (the lowermost edge of the guide rail 20).

(Functions and Effects of the First Embodiment)

The following functions and effects are obtained in the first embodiment.

(1) In the traveling body 4, the first and second fixed portions 621 and 622 of the gear housing 62 are fixed to the drum housing 61 respectively in the first region 610a and the second region 610b which are divided in the fore-and-aft direction of the vehicle by the housing space 61a and the first and second guide groove 61b and 61c. This prevents a decrease in rigidity of the drum housing 61 of the traveling body 4. In more detail, since the drum housing 61 is pulled by the wire 3 and vertically moves on the guide rail 20 while receiving a load from the windowpane 90, stress associated with the load may be concentrated on the bottom portions of the first and second guide grooves 61b and 61c and may cause deformation of the drum housing 61 if the gear housing 62 is not fixed to the drum housing 61. In the first embodiment, since the gear housing 62 is fixed to the drum housing 61 by the first and second fixed portions 621 and 622 so as to extend over the first and second regions 610a and 610b, rigidity of the drum housing 61 is reinforced and the above-described deformation is prevented. Therefore, according to the first embodiment, it is possible to ensure rigidity without increasing the thickness of the drum housing 61 and thus possible to reduce the plate thickness of the drum housing 61 of the traveling body 4. In other words, it is possible to reduce the size and weight of the window regulator 1.

(2) Since the gear housing 62 of the traveling body 4 has the third fixed portion 623 which is provided at a position offset in a direction perpendicular to the virtual line Sᵢ connecting the first fixed portion 621 to the second fixed portion 622 on the plan view in the vehicle width direction, it is possible to improve rigidity more than when fixing by the first and second fixed portions 621 and 622 at two points.

(3) The traveling body 4 has the first and second joining members 71 and 72 which join the drum housing 61 to the windowpane 90, and the first and second joining members 71 and 72 are provided respectively in the first region 610a and the second region 610b of the drum housing 61. It is thereby possible to further enhance the effects described in the above (1) and (2).

(4) Since the first to third fixed portions 621 to 623 of the gear housing 62 are fastened to the drum housing 61 by the bolts 63 and the nuts 64, the gear housing 62 is firmly fixed to the drum housing 61. It is thereby possible to reliably ensure rigidity of the drum housing 61.

Modification

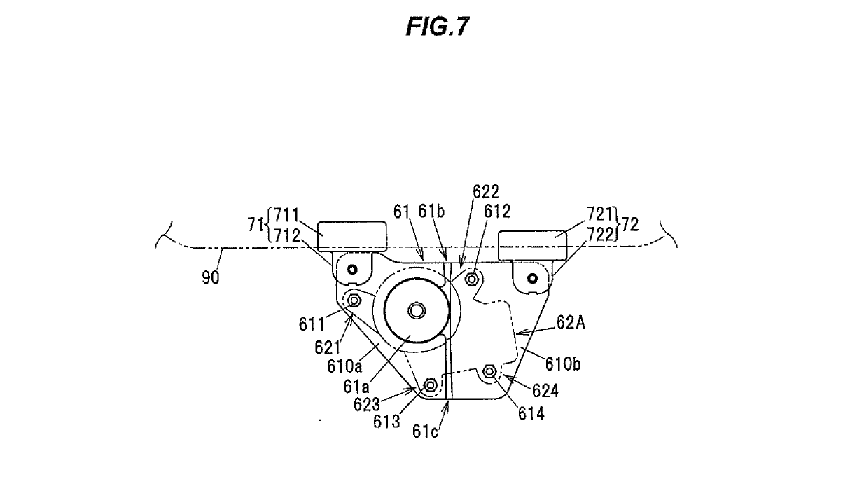

Next, the window regulator 1 in a modification of the first embodiment will be described in reference to FIG. 7. FIG. 7 is a plan view showing an example configuration of the drum housing 61 of the window regulator tin a modification. Constituent elements having substantially the same functions as those described in the first embodiment are denoted by the same reference numerals in FIG. 7 and the overlapping explanation will be omitted. In FIG. 7, a gear housing 62A is indicated by a dash-dot-dot

The window regulator 1 in the modification is different from the window regulator 1 in the first embodiment in the configuration of the gear housing, and the remaining configuration is the same. Therefore, the overlapping explanation will be omitted. The gear housing 62A in the modification has the first to third fixed portions 621 to 623 in the same manner as the first embodiment but is further provided with a fourth fixed portion 624. That is, the gear housing 62A is fixed to the drum housing 61 at four points.

As shown in FIG. 7, a bolt insertion hole 614 is formed in the second region 610b of the drum housing 61 at a position corresponding to the fourth fixed portion 624 of the gear housing 62A. The fourth fixed portion 624 is fixed in the second region 610b of the drum housing 61 and forms, together with the first to third fixed portions 621 to 623, a quadrilateral.

In the window regulator 1 in the modification configured as described above, the gear housing 62A has more fixed portions than the first embodiment. Therefore, it is possible to further enhance the effects obtained in the first embodiment.

### Second Embodiment

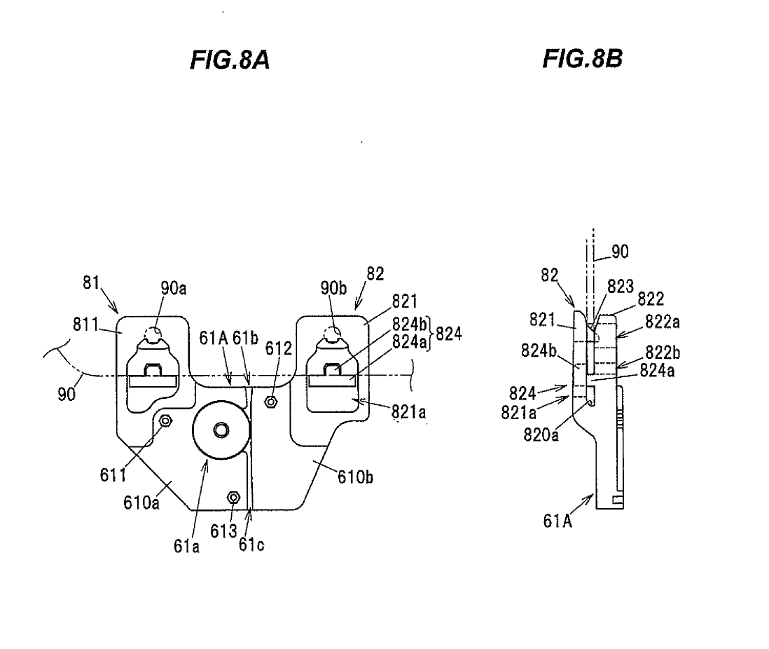

Next, the second embodiment of the invention will be described in reference to FIG. 8. A window regulator in the second embodiment is different from the window regulator 1 in the first embodiment in that the shape of a drum housing 61A is different from the shape of the drum housing 61, and the remaining configuration is the same as the window regulator 1 in the first embodiment. Constituent elements having substantially the same functions as those described in the first embodiment are denoted by the same reference numerals in FIG. 8 and the overlapping explanation will be omitted.

FIGS. 8A and 8B are diagrams showing an example configuration of the drum housing 61A of the window regulator 1 in the second embodiment, wherein FIG. 8A is a plan view and FIG. 8B is a side view.

In the second embodiment, the drum housing 61A has first and second holding portions 81 and 82 which hold the windowpane 90. That is, while the first and second joining members 71 and 72 as joint portions to be joined to the windowpane 90 are separate components from the drum housing 61 in the first embodiment, the drum housing 61A is integrally formed with the joint portions to be joined to the windowpane 90 in the second embodiment.

The first and second holding portions 81 and 82 extend upward respectively from the upper edges of the first region 610a and the second region 610b of the drum housing 61A. The first and second holding portions 81 and 82 are respectively provided in the first region 610a and the second region 610b of the drum housing 61A. Since the first and second holding portions 81 and 82 have substantially the same configuration, the second holding portion 82 will be described below as an example.

The second holding portion 82 has first and second supporting walls 821 and 822 for supporting the windowpane 90. The first supporting wall 821 and the second supporting wall 822 face to each other with a predetermined gap. The windowpane 90 is housed in a housing space 820 formed between the first and second supporting walls 821 and 822 so as to be in contact with the first and second supporting walls 821 and 822.

The first supporting wall 821 has a flange portion 823 which protrudes from a surface facing the second supporting wall 822 and is locked in a circular hole 90b formed on the windowpane 90. Thus, the windowpane 90 is held by the second holding portion 82. The first supporting wall 821 also has a substantially rectangular through-hole 821a through which a portion of the second supporting wall 822 is seen when viewing in the vehicle width direction.

As shown in FIG. 8B, the second supporting wall 822 has a protrusion 824 formed to protrude from a surface facing the first supporting wall 821. The protrusion 824 has an extension portion 824a extending from the second supporting wall 822 in the vehicle width direction to restrict vertical movement of the windowpane 90, and a protruding portion 824b protruding upward from the tip of the extension portion 824a to restrict movement of the windowpane 90 in the vehicle width direction. The tip of the extension portion 824a and the protruding portion 824b are located inside the through-hole 821a of the first supporting wall 821.

As shown in FIG. 8A, the protruding portion 824b is smaller in the left-to-right direction than the extension portion 824a and is arranged in the middle portion of the extension portion 824a. The second supporting wall 822 also has a first through-hole 822a through which the flange portion 823 of the first supporting wall 821 is seen from the outside in the vehicle width direction, and a second through-hole 822b provided below the first through-hole 822a. The flange portion 823 of the first supporting wall 821 is partially located inside the first through-hole 822a.

Functions and Effects of the Second Embodiment

In the second embodiment, in addition to the functions and effects (1) to (3) described in the first embodiment, it is possible to reduce the number of components since the first and second holding portions 81 and 82 as joint portions joined to the windowpane 90 have the flange portions 823 locked in the circular holes 90a and 90b of the windowpane 90 and this eliminates the necessity of providing the bolts 731 and 732 used in the first embodiment.

### Third Embodiment

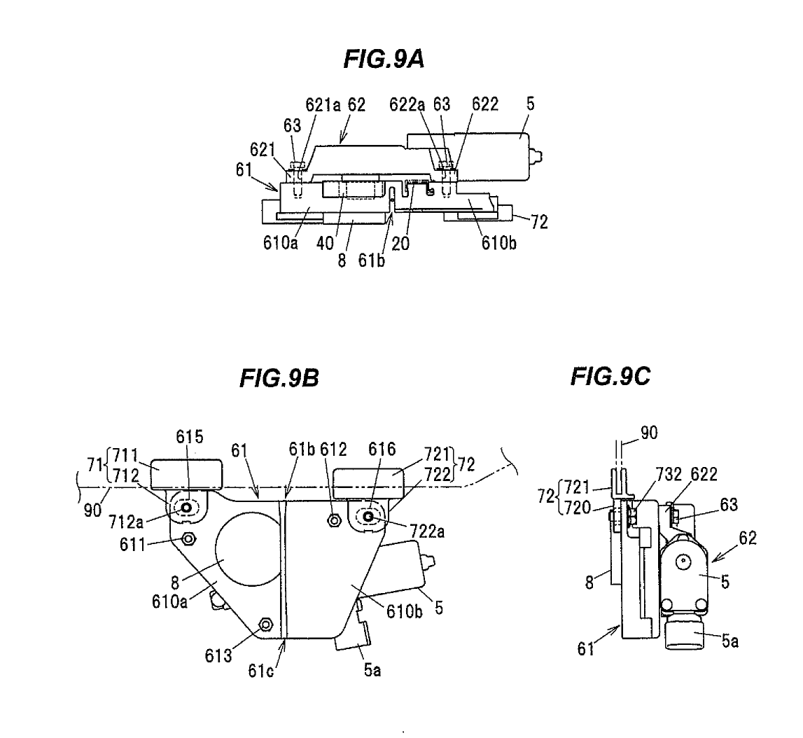

Next, the third embodiment of the invention will be described in reference to FIG. 9. A window regulator in the third embodiment is different from the window regulator 1 in the first embodiment in a position to arrange the gear housing 62 and the remaining configuration is the same as the window regulator 1 in the first embodiment.

FIGS. 9A to 9C are diagrams showing an example configuration of the housing 6 of the window regulator in the third embodiment, wherein FIG. 9A is a top view, FIG. 9B is a plan view and FIG. 9C is a side view. In the following description, a surface of the drum housing 61 on the outer side in the vehicle width direction is simply referred to as “front surface” and a surface on the inner side in the vehicle width direction as “back surface” to make the description clear. While the gear housing 62 is fixed to the front surface of the drum housing 61 in the first embodiment, the gear housing 62 is fixed to the back surface of the drum housing 61 in the second embodiment.

The housing space 61a for housing the drum 40 is formed on the back surface of the drum housing 61 so as to have an opening on the gear housing 62 side (on the right side in FIG. 9C). On the drum housing 61, the first and second guide grooves 61b and 61c for guiding the wire 3 to the housing space 61a are formed as recessed grooves having a depth in a plate thickness direction so as to open in the same direction as the housing space 61a. In addition, a substantially cylindrical cover 8 is attached to the drum housing 61 so as to close the housing space 61a. The drum 40 is thereby prevented from slipping out of the drum housing 61.

The gear housing 62 has the first to third fixed portions 621 to 623 (only the first and second fixed portions 621 and 622 are shown in FIG. 9A) in the same manner as the first embodiment. The first to third fixed portions 621 to 623 respectively have the through-holes 621a to 623a for insertion of the plural bolts 63, so that the gear housing 62 is fastened to the back surface of the drum housing 61 by the plural bolts 63 inserted into the through-holes 621a to 623a and the nuts 64.

In the third embodiment, the first fixed portion 621 and the third fixed portion 623 of the gear housing 62 are fixed to the back surface of the first region 610a and the second fixed portion 622 is fixed to the back surface of the second region 610b. In this arrangement, the gear housing 62 is fixed to the drum housing 61 so as to extend over the first and second regions 610a and 610b and strength of the drum housing 61 is thereby reinforced.

The bolt insertion holes 611 to 613 for respectively inserting the plural bolts 63 are formed on the drum housing 61 at positions corresponding to the first to third fixed portions 621 to 623 of the gear housing 62. The drum housing 61 also has the through-holes 615 and 616 formed at both edges in the fore-and-aft direction of the vehicle. The first and second joining members 71 and 72 are fixed to the drum housing 61 by the bolts 731 and 732 (shown in FIG. 1) respectively inserted into the through-holes 615 and 616. In other words, the first and second joining members 71 and 72 are respectively provided in the first region 610a and the second region 610b of the drum housing 61.

Functions and Effects of the Third Embodiment

The same functions and effects as the first embodiment can be obtained in the third embodiment. In addition, in the third embodiment, the gear housing 62 is fixed to the back surface of the drum housing 61 and it is thereby possible to reduce a protruding length of the housing 6 protruding outward in the vehicle width direction. As a result, a space for arranging components other than the window regulator, if needed, can be provided, e.g., inside the door 9 shown in FIG. 1 on the outer side of the windowpane 90 in the vehicle width direction.

Although the invention has been described based on the first to third embodiments, the invention according to claims is not to be limited to the embodiments. Further, please note that all combinations of the features described in the embodiments are not necessary to solve the problem of the invention. In addition, the invention can be appropriately modified and implemented without departing from the gist thereof.

What is claimed is:

1. A window regulator provided in a door of a vehicle to raise and lower a windowpane in the door, the window regulator comprising:
a guide rail arranged along the travel direction of the windowpane;
a wire tensely fitted along the longitudinal direction of the guide rail; and
a traveling body that is guided along the guide rail and travels together with the windowpane,
wherein the traveling body comprises a drum with a portion of the wire wound thereon, a drive mechanism that rotationally drives the drum and a housing that holds the drum and the drive mechanism,
wherein the housing comprises a drum housing with a housing space in which the drum is enclosed and a sub-housing fixed to the drum housing to house at least a portion of the drive mechanism,
wherein the drum housing comprises a recessed groove into which the wire is inserted and which communicates with the housing space, and first and second regions divided by the recessed groove and the housing space,
wherein the sub-housing comprises a main body that encloses at least a portion of the drive mechanism and a plurality of fixed portions at which the sub-housing is fixed to the drum housing, and
wherein the fixed portions comprise a first fixed portion that is fixed to the first region and a second fixed portion that is fixed to the second region.

2. The window regulator according to claim 1, wherein the plurality of fixed portions of the sub-housing further comprise a third fixed portion that is at a position offset in a direction perpendicular to a virtual line connecting the first fixed portion and the second fixed portion in a plan view along a width direction of the vehicle.

3. The window regulator according to claim 1, wherein the first and second regions of the drum housing each comprise a joint portion at which the drum housing is jointed to the windowpane.

4. The window regulator according to claim 2, wherein the first and second regions of the drum housing each comprise a joint portion at which the drum housing is jointed to the windowpane.

5. The window regulator according to claim 1, wherein the plurality of fixed portions of the sub-housing are each fixed to the drum housing by at least one bolt or rivet.

6. The window regulator according to claim 2, wherein the plurality of fixed portions of the sub-housing are each fixed to the drum housing by at least one bolt or rivet.

7. The window regulator according to claim 3, wherein the plurality of fixed portions of the sub-housing are each fixed to the drum housing by at least one bolt or rivet.

8. The window regulator according to claim 4, wherein the plurality of fixed portions of the sub-housing are each fixed to the drum housing by at least one bolt or rivet.

9. A window regulator provided in a door of a vehicle to raise and lower a windowpane in the door, the window regulator comprising:
a traveling body that holds the windowpane and travels together with the windowpane; and
a wire that pulls the traveling body,
wherein the traveling body comprises a dram with a portion of the wire wound thereon, a drive mechanism that rotationally drives the drum and a housing that holds the drum and the drive mechanism,
wherein the housing comprises a drum housing with a housing space in which the drum is enclosed and a sub-housing fixed to the drum housing to house at least a portion of the drive mechanism,
wherein the drum housing comprises a recessed groove in to which the sire is inserted and which communicates with the housing space, first and second regions divided by the recessed grooves and the housing space,
wherein the sub-housing comprises a main body that encloses at least a portion of the drive mechanism and a plurality of fixed portions at which the sub-housing is fixed to the drum housing, and
wherein the fixed portions comprise a first fixed portion that is fixed to the first region and a second fixed portion that is fixed to the second region.

10. A window regulator provided in a door of a vehicle to raise and lower a windowpane in the door, the window regulator comprising:
a traveling body that holds the windowpane and travels together with the windowpane;
a wire that pulls the traveling body; and
a drive mechanism that generates a drive force to wind the wire,
wherein the traveling body comprises a sub-housing that encloses at least a portion of the drive mechanism,
wherein the traveling body comprises a recessed groove into which the wire is inserted and which has a depth in a plate thickness direction thereof; and
wherein the sub-housing is fixed to the traveling body while striding across the recessed groove.

11. A traveling body that is adapted to be pulled by a wire wound by a drive force of a motor and travels while holding a windowpane of a vehicle, the traveling body comprising:
a drum housing that encloses a cylindrical drum on which a wire is wound; and
a sub-housing that holds the motor,
wherein the drum housing comprises a recessed groove which has a depth in a plate thickness direction thereof and extends along a travelling direction of the windowpane, and
wherein the sub-housing is fixed to the drum housing while striding across the recessed groove.

12. The traveling body according to claim 11, wherein the drum housing of the traveling body comprises first and second regions divided by the recessed grooves,
wherein the sub-housing comprises a plurality of fixed portions that are fixed to the drum housing, and
wherein the fixed portions comprise a first fixed portion that is fixed to the first region and a second fixed portion that is fixed to the second region.
